(19) United States
(12) Patent Application Publication
(10) Pub. No.: US 2004/0131426 A1
(43) Pub. Date: Jul. 8, 2004

(54) Device for breaking up pipelines

(76) Inventor: Franz-Josef Puttmann, Lennestadt (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/469,891

(22) PCT Filed: Mar. 7, 2002
(86) PCT No.: PCT/EP02/02535

(30) Foreign Application Priority Data
Mar. 8, 2001 (DE) 101 11 406.0

(51) Int. Cl. F16L 55/18; F16L 55/44

(52) U.S. Cl. 405/184.3; 405/184.1

(57) ABSTRACT

The invention relates to a device for splitting old pipes by means of cutting rollers arranged next to one another on a body, in which case the revolving cutting edges of adjacent cutting rollers do not lie in one plane.

The invention relates to a device for splitting pipelines and claims the priority of German Patent Application 101 11 406.0, to which reference is made with regard to contents.

To replace old lines, it is known to destroy them by the “pipe bursting method” and to pull a new pipe or cable lines into the line of the old pipe. In this case, the old pipe is broken up or severed by means of a bursting or cutting tool and displaced into the earth at the side by the bursting or cutting head being moved through the line of the old pipe by means of a pulling or pushing implement and by the pipe shell being pressed by means of a following expansion head into the earth surrounding the pipe.

When the pipe is being broken up by means of a bursting head, the pipe is split into a multiplicity of fragments. These fragments may constitute a risk for the new pipe, in particular if the new pipe involves polyethylene pipes or other plastic pipes. In this case, the risk originating from the fragments of the old pipe is further increased due to the pressure emanating from the relaxing earth on the new pipe pulled in. Thus, it may be the case, for example, that a fragment is produced during the bursting and this fragment comes to lie with its sharp-edged fracture area on the shell of the pipe newly pulled in. If the laterally displaced earth now exerts a pressure on this fragment, damage to the pipe pulled in is inevitable.

This risk is reduced by the old pipe being cut open instead of being broken up. Various devices which have recourse to static blades or blades working as rollers have been developed for this purpose. The old pipe can thus be severed by blades of different kinds without there being the risk of fragment formation.

Roller blades have proved to be advantageous, since they minimize the high pushing or pulling force, required in particular for ductile cast pipes, on account of their increased efficiency compared with fixed knife-edges. Thus, roller blades have been developed in which a plurality of cutting rollers are arranged opposite one another on a conical support. Since these cutting rollers must have a relatively small radius on account of the limited space available in the pipe, the introduction of force via the roller axis into the cutting point is only limited, since the radially acting force component is small. Larger cutting rollers have been used in order to optimize the introduction of force, in which cutting rollers the radial force component was increased on account of the roller center point being further away from the cutting point in the radial direction. In order to be able to arrange these rollers in the tool body, the rollers were arranged only on one tool side because of the lack of space available, whereas a rail or small supporting rollers were provided on the opposite tool side. The result of this, however, was that the pipe was not split in two but was severed only along a line, as a result of which deformation forces in addition to the displacement forces for the earth to be displaced had to be overcome during the expansion by means of the expansion head. Furthermore, the elastic deformation proportions in this technique lead to a recovery, which is additionally assisted by the relaxing surrounding earth. In this case, there is the risk that, due to the recovering pipe, stones which have penetrated into the cut opening from the surrounding earth may in turn lead to damage to the new pipe.

In order to avoid said deformation forces, recourse is had to a tool having a double cutting line and thus cutting rollers arranged opposite one another. In order to use the advantageous introduction of force of larger cutting rollers in this case, these cutting rollers are arranged opposite one another such as to be offset one behind the other. In this case, however, the problem again arises that the tool becomes wedged in the pipe shell due to the axially offset introduction of force, and thus considerable frictional forces are to be overcome by the pushing or pulling implement. Occasionally the pipe was not cut open but was ripped by the following expansion head, since the force introduced into the pipe shell via the cutting rollers was not sufficient to cut open the pipe, and the old pipe spread out (ripped) on the tool body.

The object of the invention, then, is to provide a method and a device for the destructive replacement of old lines, in which method at least some of the disadvantages of the prior art are avoided.

The object is achieved by the subject matter of the dependent claims. Special configurations are the subject matter of the subclaims.

In accordance with the method according to the invention, the old pipe is severed on at least two circumferential lines which are essentially arranged in the horizontal. This results, for example, in two half-shell old pipe halves, so that, on the one hand, no substantial deformation force with regard to the pipe shell has to be applied for the expansion and, on the other hand, entry of surrounding earth or stones into the cut opening due to gravitational force is avoided. The pushing or pulling force can thus be largely used for the requisite cutting forces and, during the use of an expansion head, the displacement work with regard to the surrounding earth can [lacuna].

A suitable device for carrying out this method is a two-edged roller blade having cutting rollers arranged opposite one another. According to the invention, however, these particular cutting rollers have a large diameter, so that the introduction of force into the pipe shell via the roller axis is optimized. This is achieved by the roller axis being as far away from the pipe shell as possible. The spatial limit due to the cutting rollers arranged radially opposite one another in the prior art is overcome according to the invention by the cutting rollers having a slightly offset cutting plane, so that the cutting rollers lie next to one another with part of their surface. The cutting points of the rollers, with an appropriate configuration of the rollers radially opposite one another, can both be arranged virtually in the axial plane. The rollers are therefore preferably arranged parallel to one another at the smallest possible distance apart, so that the cutting surfaces lie essentially in one plane. This effect can be intensified by the roller surfaces which face one another being of planar design and leading in a planar manner into the respective cutting edge of the rollers, so that the cutting edge lies on the plane of the roller surface facing the respective opposite rollers [sic]. The remote roller side then has the bevel required for forming a cutting edge.

The rollers are preferably mounted on a bolt which is fixed in the roller body and which has two axle bearings which are offset in the cutting plane and slightly orthogonally in the roller axis plane but not along the axis. The axle bearings may have a different diameter, and the axle bearing having the smaller diameter may be arranged on the end face of the axle bearing having the larger diameter.

The body of the cutting tool may have a through-hole into which the bolt is pushed and fixed in a positive-locking manner. In this case, the cutting rollers can be inserted into a slotted hole arranged perpendicularly to the through-hole, so that the rollers, when the bolt is inserted into the through-hole, are pushed onto the respective axle bearing of the bolt and are fixed radially and axially in the body.

This device is suitable in particular for cutting ductile cast materials.

To cut a ductile cast pipe having a certain diameter and a certain wall thickness, a preferred method is used in which the sleeve sections, which have a certain wall thickness, are merely weakened or only severed on one side, but are not ripped open on both sides, by means of a device according to the invention, in which the radial outer points of the respective roller cutting surfaces are arranged at a certain distance, so that the sleeve remains essentially intact or at any rate does not form two half pieces. The requisite distance between the radial outer points can be determined in a simple manner by the distance being gradually reduced or increased until the desired weakening or severing on one side occurs. A considerable disadvantage of conventional pipe cutting systems having an expansion body is overcome by the use of such an arrangement.

During the severing of an old pipe with a conventional cutting device, there is often the problem that a severed pipe section, by the pressure exerted on this pipe section in the axial direction by the expansion body, is pushed over the pipe section in front of it, which has not yet been severed, as soon as the first pipe section has been completely severed. This is avoided by the described embodiment of the invention, since the sleeve region of the severed pipe section is merely weakened and not severed, so that said pipe section remains fixed on the pipe section in front of it. The sleeve region is burst only by the expansion body, although the expansion body has then already left the preceding pipe section.

Even though the invention has been described with reference to pipelines, its range of use is not restricted solely to such pipelines. On the contrary, use is conceivable for any object in which opposite surfaces are to be severed and cutting-roller cross sections which are as large as possible are advantageous.

The invention is explained in more detail below with reference to an exemplary embodiment shown in the drawing.

In the drawing:

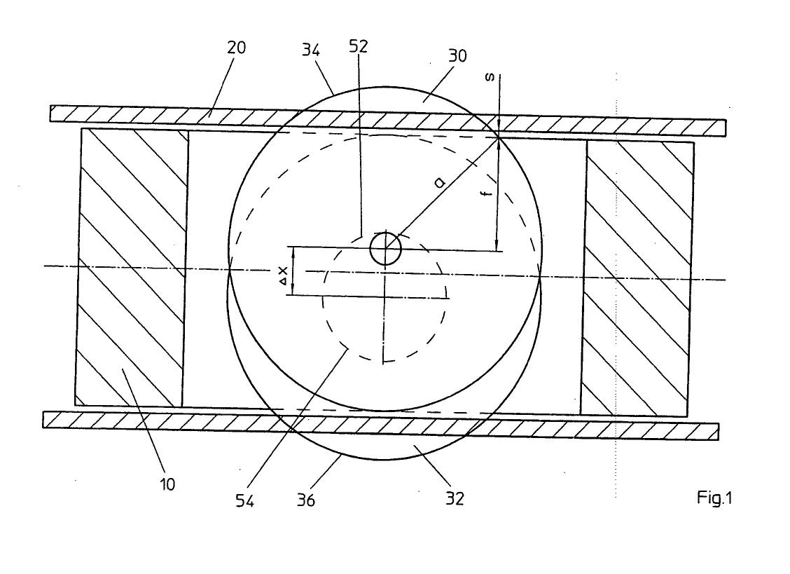

FIG. 1 shows a longitudinal section through the device according to the invention in an old pipe,

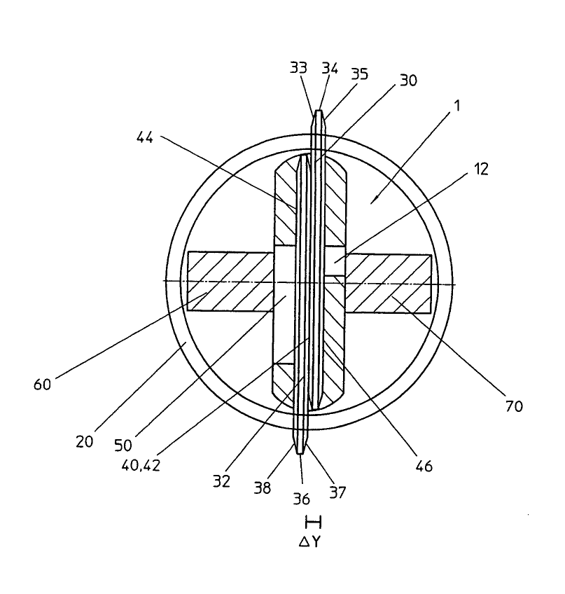

FIG. 2 shows the device of FIG. 1 in a cross section,

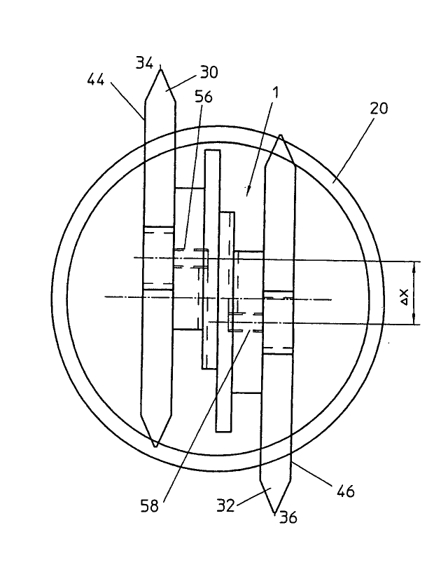

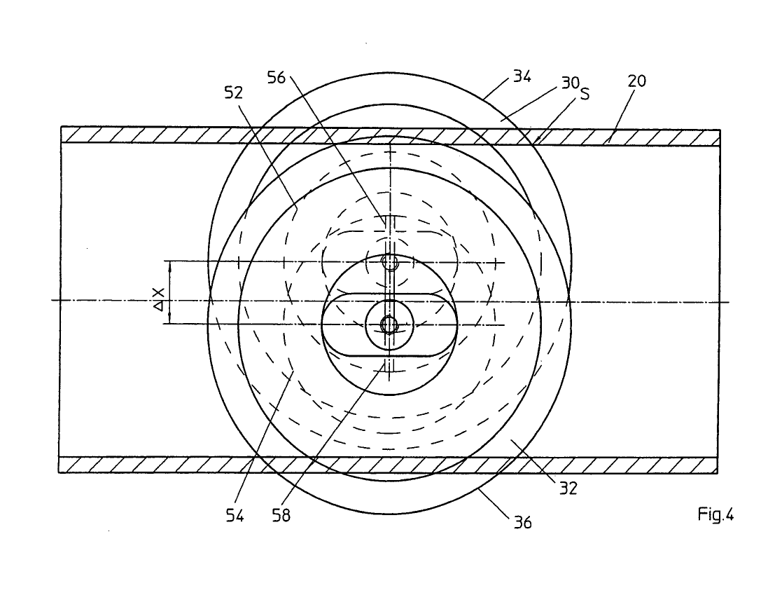

FIGS. 3 and 4 show a device according to FIG. 1 with passages for the lubrication and another axle bearing configuration, and

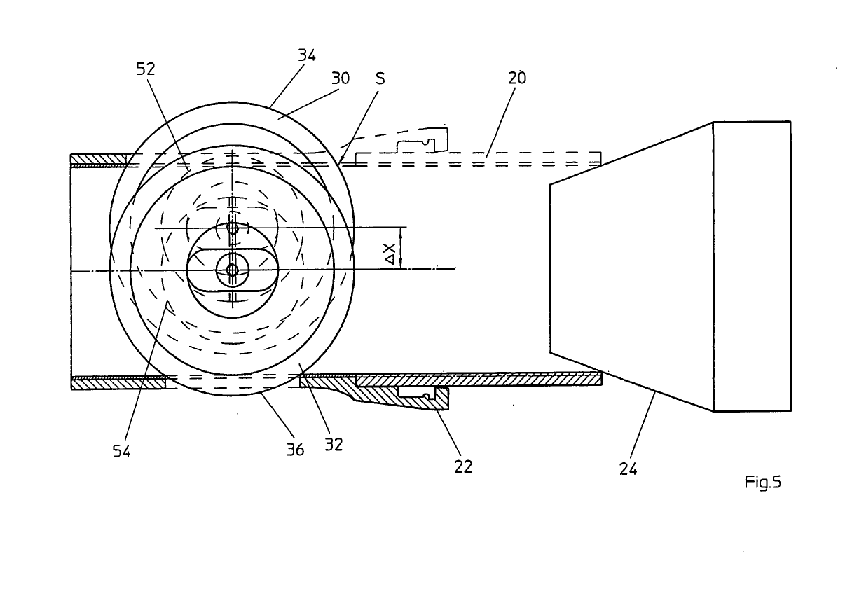

FIG. 5 shows a sequence of the pipe severing according to the invention.

The body 10 of the device 1 according to the invention is shown with two cutting rollers 30, 32 in an old pipe 20. The cutting rollers 30, 32 have cutting edges 34, 36. The cutting surfaces are formed by bevels 33, 35 and 38, 37 on both sides. The rollers have end faces 40, 42 facing one another and outer surfaces 44, 46 facing away from one another.

In order to bring the cutting edges 34 and 36 and thus the respective cutting planes running through these cutting edges closer to one another, the cutting edge 34, 36 may be formed in each case by only one bevel 38, 35 on the outer surface 44, 46, so that the roller faces 40, 42 facing one another and the cutting edges 34, 36 are made virtually congruent.

The cutting rollers 30, 32 are mounted on a bolt 50 which is fixed in a through-hole 12 in the body 10 in a positive-locking manner.

In order to avoid deformation of the pipe 20 during the cutting, the bolt 50 or the tool 10 may have supporting rails or supporting rollers 60, 70.

The bolt 50 has an axle bearing 52, 54 for each roller 30, 32. The axle bearings 52, 54 are arranged in such a way that the axes A₃₀ and A₃₂ of the rollers 30 and 32 have a radial offset ΔX in the section plane and a radial offset ΔY in the axial plane. The axle bearings 52, 54 have passages 56, 58 for the lubrication of the rollers, so that the lubricant is distributed over old contact surfaces by the movement of the rollers.

FIG. 5 shows how the device according to the invention is pulled in three steps over a sleeve section 22 by an expansion body 24, in the course of which the sleeve section 22 is deformed but not completely severed, but rather is only severed in the third step by the expansion body 24. To this end, the expansion body may in turn have separate cutting tools.

As can be seen in the drawing, as large an orthogonal force component f as possible in the radial direction is possible using as large a roller as possible having as large a distance a of the axis as possible from the cutting point s.

1. Device for splitting old pipes from inside by means of cutting rollers (30, 32) arranged on a body (10) next to one another relative to the longitudinal axis of the body, characterized in that the revolving cutting edges (34, 36) of adjacent cutting rollers do not lie in one plane.

2. Device for splitting old pipes from inside by means of rotating cutting elements, characterized in that the cutting planes of the cutting elements are arranged offset from one another radially relative to the pipe radius and the circular areas described by the cutting edges (34, 36) are made partly congruent in plan view of the circular areas.

3. Device according to claim 1 or 2, characterized in that the revolving cutting edges each have only one bevel (35, 38), the bevel lying on the outer surface (44, 46) of the cutting rollers (30, 32) and having planar end faces (40, 42) arranged parallel to one another.

4. Device according to one of the preceding claims, characterized in that the rollers are mounted on a bolt (50) which is fixed in the body (10) and on which two axle bearings (52, 54) for cutting rollers are arranged next to one another in such a way that the axes of rotation of the cutting rollers are offset in the direction of the cutting edges.

5. Device according to one of the preceding claims, characterized in that the bolt (50) has two axle bearings (52, 54) of different diameter, the axle bearing having the smaller diameter being arranged eccentrically on the end face of the axle bearing having the larger diameter.

6. Device according to one of the preceding claims, characterized in that the body (10) has a through-hole in which the bolt (50) is pushed and fixed in a positive-locking manner.

7. Device for longitudinally splitting pipes from inside, having at least two rotating tools (30, 32) for severing the pipe shell, characterized in that the surfaces of rotation at least partly overlap in the direction of a pipe radius.

8. Device according to one of the preceding claims, characterized in that the bolt (50) and/or the axle bearings (52, 54) have passages (56, 58) for a lubricant.
